(19) United States
(12) Patent Application Publication
(10) Pub. No.: US 2007/0161355 A1
(43) Pub. Date: Jul. 12, 2007

(54) Method and system for remote communication of telematics data

(76) Inventor: Xianguang Zeng, Ottawa (CA)

Correspondence Address: Xianguang Zeng, 15 State Street, Ottawa, K2C 4B3, CA

(21) Appl. No.: 11/397,978

(22) Filed: Apr. 6, 2006

(30) Foreign Application Priority Data
Aug. 5, 2005 (CN) 200510089172.1

(51) Int. Cl. H04B 1/034

(52) U.S. Cl. 455/99; 340/870.01; 340/539.1; 340/426.19

(57) ABSTRACT

The invention embodies a remote communication device and a remote communication system. The invention also embodies a communication protocol and method to communicate between remote devices and data service centers. During the transmission, the data is modulated into a voice signal, instead of using expensive wideband resources, which reduce the bandwidth and the cost of the communication. The invention also increases the security of the data transmissions.

### FIELD OF THE INVENTION

The invention belongs to the field of data communication. The invention embodies a remote data communication device and system for transmitting data over a voice network of a cellular phone.

### BACKGROUND INFORMATION

The field of telematics is a rapidly expanding industry. Telematics is used to transmit data from remote locations to a central location. Telematics allows a user to transmit information regarding his/her safety, environment, status and can also be used to transmit entertainment-related information. Because of the above benefits, telematics has been developed quickly in industrialized countries. Currently, telematics integrates wireless, GPS, mobile Internet technologies between vehicles, airplanes, ships and people. Existing telematics systems require that communication with the service center or back office, uses special wideband and service such as GPRS, 1XRTT, and other 3G networks and Internet. As is well known to the wireless community, the frequency resources are very limited so that the cost of wideband communication is high. Thus the telematics devices and maintenance are expensive, and users have to pay multiple fees to the providers.

One drawback of existing systems is that hackers can break into telematics data which are transmitted over the Internet. This forces the telematics users to pay a high price for their data integrity and security, even though the data might never reach its intended destination, due to the internet's weak security.

Without solving these problems, telematics is of limited usefulness.

### SUMMARY OF THE INVENTION

This invention allows its users to use less expensive transmission protocols and reduces the high costs associated with the special wideband services that are commonly used now. The invention formulates communication methods which use public or private voice channel networks. The invention comprises mobile vehicle, and or personal devices in combination with a service center or other back office devices.

The referred to mobile vehicle devices include a data-collection module, voice-signal module and a control module. The data collection module gathers vehicle operating data or information relating to personal status. The voice-signal module modulates the data into a voice signal and also demodulates the voice signal to data and sends or receives voice signals to or from the transmitting module. The control module receives and stores the vehicle operation (or personal) data, generates, outputs or inputs those voice signals to or from public or private cellular communication networks. The information-collection and voice-signal modules are connected to the control module.

The service center or back-office devices include a voice-signal module and a control module. The voice-signal module converts the data into a voice signal-it also converts a voice signal to data. The voice-signal module also sends or receives voice signals into or from transmitting module. The control module receives and stores the vehicle operation data, outputs or inputs those voice signals to or from public or private cellular communication networks.

The service center or back office includes a voice-signal module which modulates the data into voice signal as well as voice signal to the data and sends/receives voice signals into/from transmitting module and control module which receives and stores the vehicle operation data, and or personal status, and outputs/inputs those voice signals to/from public/private communication networks.

The invention also provides a remote communication method between vehicle devices (or personal devices) and service centers or back offices. The method functions as follows: the information on the sender's side is modulated into a voice signal by the sender's voice-signal module; the voice signal is transmitted to a receiver through public/private wireless networks; the receiver's voice-signal module receives the voice signal and demodulates the voice signal back to data.

The invention also makes the above methods and devices transparent to their carriers. An approach of combining Phase Shift Keying (PSK) and encoding techniques to suppress a VOCODER have been developed. Phase Shift Keying is a means of transmitting information using a radio carrier signal and is familiar to practitioners skilled in the art. A VOCODER is a device which converts information between voice and digital domains and is also familiar to practitioners skilled in the art.

Using a voice channel instead of expensive wideband resources to transmit the data, the invention reduces greatly the costs associated with telematics. On the other hand, since the data are transmitted by non-public methods and protocols, combined with encryption techniques, the invention increases greatly the general security of using telematics.

The present invention is described herein using an example of a vehicle which transmits and receives telematics information. There are other examples which could have been used. One of these is a medical patient who transmits biometric data. The fact that a vehicle is used as the example does not limit the intended uses of this invention.

### BRIEF OF THE DRAWING

FIG. 1 shows the block diagram of the on-vehicle component of the present invention.

FIG. 2 demonstrates the remote communication between a vehicle and a service center or back office, according to the present invention.

FIG. 3 shows the flow chart of the remote data transmission method, according to the present invention.

FIG. 4 shows the data format of the data-link layer protocol of the present invention.

FIG. 5 shows the application layer protocol of the present invention.

### DETAILED DESCRIPTION OF THE DRAWINGS

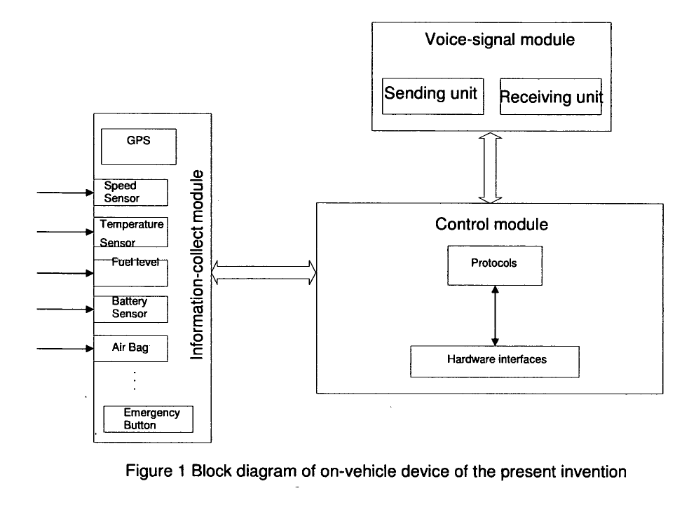

FIG. 1 shows the system module diagrams of the vehicle telematics devices of the present invention.

The information-collection module collects the data from vehicle operating sensors, switch inputs such as SOS push button, and GPS signal processor. The vehicle operating sensor data is the real-time vehicle operating signals such as speed, temperature, fuel level, status of electric equipment, etc. The information-collection module also collects operating signals from data-links such as RS232, RS485 and CAN from which electronic control units (ECU) communicate with each other.

According to the present invention, a multi-standard modem, CMX868, is used as the hardware of the voice-signal module, through which the digital communication between the service center or back office and the vehicle telematics is transmitted as voice signals using low-bandwidth voice channel.

According to the present invention, a 16 bit microprocessor MC9S12 is used as the CPU of the control module, which is implemented as an embedded system using a standard real-time operating system such as vxWorks, Windows CE, Linux etc.

The control module includes hardware interfaces which are presented as device drivers during the implementation. The device drivers are the interfaces such as CAN protocols, GPS, modem, RS232, RS485/J1708, J1850, RTC, A/D, and I/O. All interface with the hardware peripheries are implemented by a operating system's API “write” or “read”, in which the “write” is output and the “read” is input.

Besides the digital I/O, the control module includes power output drivers which drive larger power units on a vehicle, such as signal lights, rain wiper etc.

The control module also includes wireless communication interfaces and protocols, in which the “read” receives the data from voice-signal module; the “write” sends the data to voice-signal module; the protocols insert the data into frames during transmitting, and extract the data from frames during receiving.

The control module includes management of memories, such as Flash EEPROM, RAM, and EEPROM.

The vehicle telematics device has two working modes, or normal working mode and power saving mode. When 1) engine and ignition key are off; and 2) no traffic appears on data links (J1939/J1708/J1850, RS232 or wireless communication) at least 1-3 minutes whose value could be a programmable parameter; and 3) GPS position is fixed; and 4) emergency situation has been cleared, the device enters power saving mode. When 5) engine or ignition key is on; or 6) any traffic is detected on the data links of J1939/J1708/J1850, RS232 or wireless communication; or 7) emergency button is pushed; or 8) time is alarm time that was set by a real time clock (RTC), the device wakes up from the power saving mode and enters normal working mode.

The above working mode transformation is implemented through interrupts of the CPU. When the device is installed or its power connected, the embedded code started to run and entered the normal working mode. If all 1-4 above conditions are satisfied, the device will transform itself into the power saving mode in which electric current shall be less that 15 mA (current driven by RF devices, such as cell phone, radio, is not included). If any one of above 5-8 conditions occurs, for instance when service center or back office made a contact request, the signal from CMX868's RXA pin would generate an interrupt of the CPU, the device would wake up and entered normal working mode.

During the normal working mode, the device keeps monitoring the data links and other inputs. The inputs are processed, stored in RAM or Flash EEPROM, and sent to the service center if necessary. For instance, a fuel sensor ECU broadcasts fuel level on CAN bus; the above (CAN) message enters the device's CAN transistor (PCA82C251) from CANL and CANH; the control module picks up the message based on SAEJ1939 protocol, processes a report, and stores it into RAM or Flash EEPROM; the control module later sends the report to the service center or back office. Transmitting method and protocols will be discussed in details in the later sections. On the other hands, if the monitored signals are analog sensors, such as a temperature sensor, A/D converters inside the CPU will convert the analog voltages into digital values. According to the present invention, the CPU PAD00-16 pins are set as analog sensor inputs.

Any kinds of GPS OEM, such as RFDomus RFD1400, may be used as a position device according to the present invention.

In general, all kinds of sensors and signals, not limited as above mentioned, operating data, vehicle position info, and emergency messages etc. can be monitored by the control module and generated into the reports which are transmitted to the service center or back office. The service center or back office also can originate contact with the vehicle telematics. For instance, the service center might send a request which is modulated into voice signal to transmit to the vehicle telematics' voice-signal module, which converts and passes the command to the control module, the control module instructs a power driver to shut down an on-vehicle device, such as an engine etc.

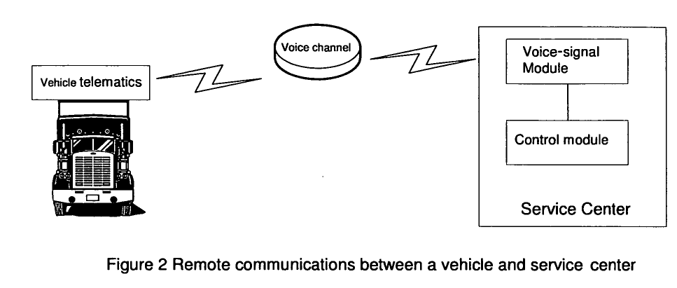

FIG. 2 demonstrates the remote communication between a vehicle and service center, in according to the present invention.

The remote communication between a vehicle and service center or back office is established on one of existing wireless networks, such as public phone networks, private or business radio (networks), and satellite communication networks. As long as a communication system supports voice, it can be the transmission medium for the present invention. The service center or back office system includes voice-signal and control modules, in which the voice-signal module modulates the data into voice signal as well as voice signal to the data and sends/receives voice signals into/from transmitting device; the control module processes/prepares data and sends/receives data from the voice-signal module. The service center or back office may also a) include a single or multiple phone lines; b) use a PC as server or connect to LAN and share the information with other computers.

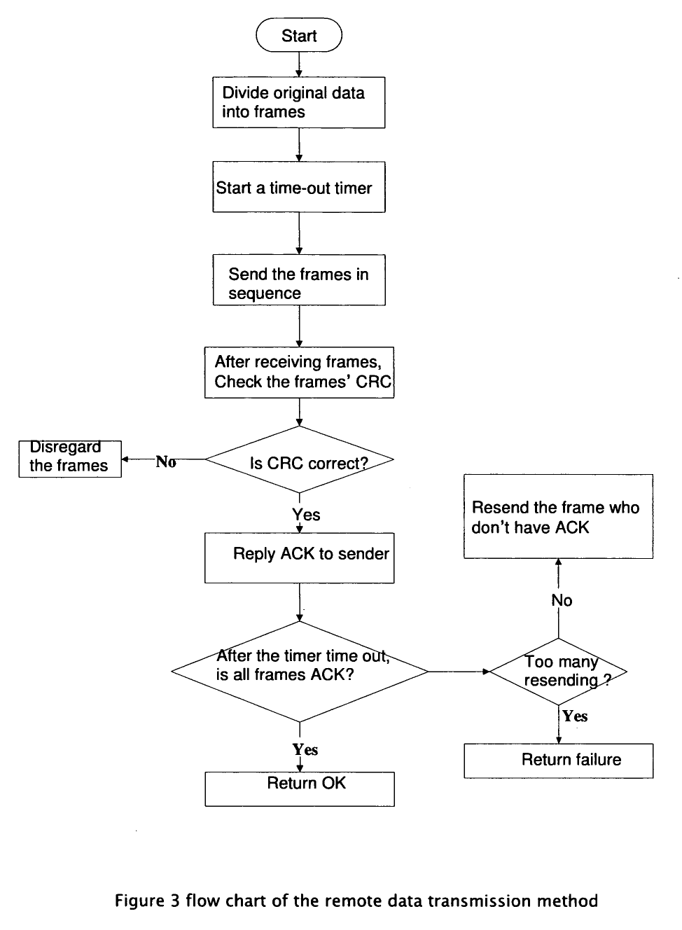

FIG. 3 shows the flow chart of the remote data transmission method, in accordance with the present invention. The flow chart explains the data traffic of the application layer between a sender and receiver.

1^{st}, the task of the sender divides the original data block into several frames, 2^{nd}, the task of the sender sets a time out timer, 3^{rd}, the task of the sender moves those frames to the voice-signal module which modulates the frames with 1200/2400 Hz PSK (phase shift key), 4^{th}, the task of sender waits for the timer timing out; 5^{th}, the voice-signal module transmits those voice signals out in sequence; 6^{th}, if receiving those frames, the receiver checks the CRC (Cyclic redundancy check) of every frame; 7^{th}, the receiver acknowledges (ACK) every frame which has passed CRC to the sender; 8^{th}, when the timer timing out, the task of the sender checks ACK and resends those frames who do not get ACK as steps 2^{nd} -7^{th}. During the transmission, the control module sets a limit on numbers of resending. If the task of the sender could not get all ACK within the limited numbers, it would give up sending and return ERROR to report a failure.

The above data transmitting procedure is executed based on predefined protocols between the sender and receiver. The protocols involved here are physical layer, data layer and application layer. Since the physical layer protocol is defined by hardware or devices, only the protocols of physical and application layers are defined in the present invention.

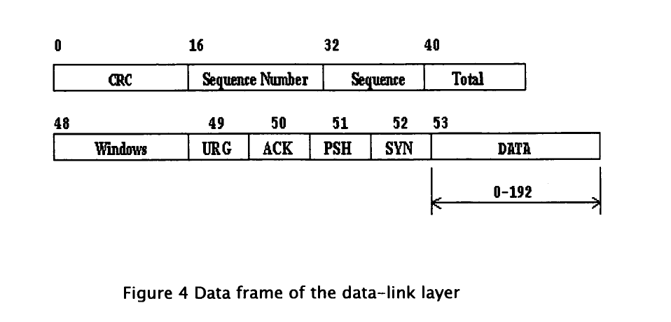

FIG. 4 shows the data format of the data-link layer protocol of the present invention. In the data-link layer, the original data is a group of binary bits which are enclosed into one or numerous frames as shown in the figure. Where CRC-16 bits cyclic redundant check, the check sum from bit 16 to the end of the frame; Sequence number—sequence number to identify an information block; Sequence—the sequence of the frame within the information block; Total—the total numbers of the frames within the information block; Windows-1bit of 0 or 1 (0 stands for DATA size is 0, and 1 stands for DATA size is 192); URG—urgent bit of 0 or 1 (1 for yes, 0 for no); ACK—acknowledgement bit of 0 or 1 (1 for yes, 0 for no); PSH—push bit of 0 or 1 (1 for yes, 0 for no); SYN—synchronize bit of 0 or 1 (1 for yes, 0 for no); DATA—information data stream, with a size of 0 bit or 192 bits.

Before sending, the sender divides the original binary data into one or several 0 or 192 bits frames which are filled correctly based on the above definitions.

After demodulating, the receiver first checks the CRC of each frame, if all the CRC are correct, assembles those bits back to original binary data based on the above definitions.

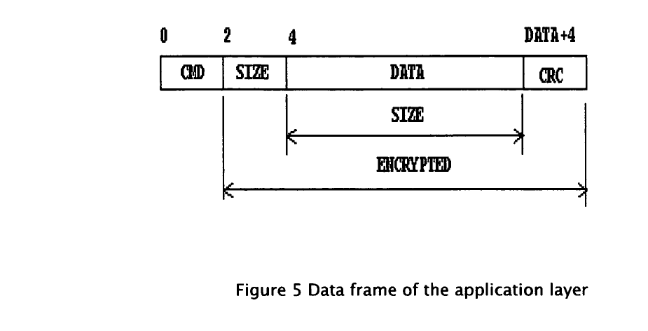

FIG. 5 shows the data format of the application layer protocol of the present invention. In the application layer, the original data is a byte stream which is enclosed into one or numerous frames as shown in the figure. Where CMD is the command; SIZE is the size of the data; CRC is the value of CRC16 for the byte stream (data+CMD). The DATA could also be encrypted by an encryption method.

The data encryption or encoding is necessary because the encryption or encoding randomizes the bit distribution so that the VOCODER cannot treat a meaningful message such as a sequence of one hundred zeros as noise.

What is claimed is:

1. A remote communication method between a mobile telematics transmitting device and a service or back-office center, comprising: a sender which modulates data into voice signals which are then transmitted over a wireless voice channel; a receiver which receives the voice signals over the voice channel and demodulates the voice signals back to data.

2. The method of claim 1, wherein a method of transmitting data through a voice channel, said data having a bit distribution, said method comprising the steps of:
a) Providing a transmitter having a VOCODER, said transmitter operable over said voice channel;
b) Encoding said data to produce encoded data, said encoded data having a randomized bit distribution;
c) Creating a modulated signal representing said encoded data; and,
d) Transmitting said modulated signal with said transmitter over said voice channel.
Whereby said encoded data is transmitted via said voice channel without being suppressed by said VOCODER.

3. The method of claim 1, wherein the method of claim 2 wherein creating step c) comprises Phase Shift Key.

4. The methods of claim 1, wherein further comprising the steps of:
a) Providing a receiver having access to said voice channel;
b) Receiving said modulated signal;
c) Demodulating said modulated signal to obtain a copy of said encoded data; and,
d) Decoding said copy of said encoded data to obtain a copy of said data;
Whereby said data is transmitted to said receiver.

5. The method of claim 1, wherein the sender sets a time-out timer after sending the frames; the sender resends the frames which are not acknowledged after the timer timing out; the task of sender will return to the caller with a success if all frames have been acknowledged, or with a failure if not all frames have been acknowledged after a limited numbers of re-sends.

6. The method of claim 1, wherein the sender is the telematics device, the receiver is the service center or back office.

7. The method of claim 1, wherein the sender is the service center or back office, the receiver is the telematics device.

8. The method of claim 1, wherein the voice channel includes public or private cell phone networks.

9. A remote telematics device, including: an information-collection module, a voice-signal and control modules. The information-collection module gathers remote operating data; the voice-signal module consisting of one sub-module, modulates the transmitted data to voice signals and other sub-module demodulates voice signals to received data. The control module processes and stores data from the information-collection module; generates reports to a service center or back office; communicates with public/private voice channel networks; sends and receives data from the voice-signal module.

10. The device of claim 9, wherein the information-collection module includes remote sensors.

11. The device of claim 9, wherein the voice-signal module includes one modulator modulating data into voice signals and other demodulator demodulating voice signals into data.

12. The device of claim 9, wherein the control module includes hardware interfaces, functional interface, and communication protocols. The hardware interfaces are expressed as device drivers; the functional interfaces send data to the voice-signal module, receive from the voice-signal module, and “read” or “write” from the device drivers. The communication protocols enclose the transmitting data into frames and assemble data from the receiving frames.

13. The device of claim 12, wherein the device drivers include CAN bus, GPS processor, modem, RS232, RS485/J1708, J1850, and analog/digital interfaces.

14. The device of claim 9, wherein the voice channel includes public cell phone networks.

15. A remote communication system, including remote telematics devices and service center or back office. The remote telematics device includes information-collection, voice-signal, and control modules. The information-collection module is used to gather remote operating data; the voice-signal module includes a sending unit to modulate data into voice signals, a receiving unit to demodulate the voice signals to data; the control module processes, stores the remote operating data from the information-collection module, generates reports, communicates with wireless networks, sends and receives from the voice-signal module.
The service center or back office includes voice-signal module and control module. The voice-signal module consists of a sending unit which modulates data into voice signals that are transmitted by a voice channel, a receiving unit which demodulates voice signal from a voice channel into data. The control module sends data to the voice-signal module, receives data from the voice-signal module.

16. The system of claim 15, wherein the service center or back office is connected to the corporation's LAN or Internet.

17. The system of claim 15, wherein the information-collection module includes remote operating sensors.

18. The system of claim 15, wherein the voice-signal module includes one modulator modulating data into voice signals and other demodulator demodulating voice signals into data.

19. The system of claim 15, wherein the received data is decrypted or decoded back to the original sent data.

20. The system of claim 15, wherein the control module includes hardware interfaces, functional interfaces, and communication protocols. The hardware interfaces are expressed as device drivers; the functional interfaces send data to the voice-signal module, receive from the voice-signal module, and “read” or “write” from the device drivers. The communication protocols enclose the transmitting data into frames and assemble data from the receiving frames.

21. The system of claim 15, wherein the device drivers include CAN bus, GPS processor, modem, RS232, RS485/J1708, J1850, and analog/digital interfaces.

22. The system of claim 15, wherein the voice channel includes public cell phone networks.
